(19) United States
(12) Patent Application Publication
(10) Pub. No.: US 2016/0356632 A1
(43) Pub. Date: Dec. 8, 2016

(54) SENSOR DEGRADATION COMPENSATION

(71) Applicant: EMPIRE TECHNOLOGY DEVELOPMENT LLC, Wilmington, DE (US)

(72) Inventors: Raghuram MADABUSHI, Seattle, WA (US); David ROSENBERG, San Francisco, CA (US); Mark Loren GRIFFIN, Fairfax, CA (US); Michael John NICHOLLS, Freemans Reach (AU)

(21) Appl. No.: 14/728,850

(22) Filed: Jun. 2, 2015

(51) Int. Cl. G01D 18/00

(52) U.S. Cl. CPC G01D 18/00

(57) ABSTRACT

In some examples, a method of sensor degradation compensation is described. The method may include generating first characterization data for calibration of a first sensor, from amongst multiple sensors that include the first sensor and at least a second sensor, based on first sensor data generated by the first sensor. The method may further include providing the first characterization data to be pushed to the second sensor. The second sensor may be configured to be calibrated with the first characterization data. The method may also include collecting second sensor data generated by the first sensor and generating second characterization data based on the second sensor data after the first characterization data is provided. The method may further include providing the second characterization data to be pushed to the second sensor. The second sensor may be configured to be recalibrated with the second characterization data.

### BACKGROUND

Sensors may be used commercially as well as personally to provide information about environments around the sensors. For example, sensors may be used to monitor a person's vital signs, pipe lines, manufacturing equipment, among other types of uses. Generally, sensors' characteristics may change over time due to age or other factors. A change in sensor characteristics may result in inaccurate sensor data, which may be problematic in some situations.

Unless otherwise indicated herein, the materials described herein are not prior art to the claims in the present application and are not admitted to be prior art by inclusion in this section.

### SUMMARY

Techniques described herein generally relate to sensor degradation compensation.

In some examples, a method of sensor degradation compensation is described. The method may include generating first characterization data for calibration of a first sensor, from amongst multiple sensors that include the first sensor and at least a second sensor, based on first sensor data generated by the first sensor. The method may further include providing the first characterization data to be pushed to the second sensor. The second sensor may be configured to be calibrated with the first characterization data. The method may also include collecting second sensor data generated by the first sensor and generating second characterization data based on the second sensor data after the first characterization data is provided. The method may further include providing the second characterization data to be pushed to the second sensor. The second sensor may be configured to be recalibrated with the second characterization data.

In some examples, a method of sensor degradation compensation may be described. The method may include generating first characterization data for calibration of a first sensor, from amongst multiple sensors that include the first sensor and at least a second sensor, based on first calibration sensor data from the first sensor. The method may further include providing the first characterization data to be pushed to a device associated with the second sensor. The first characterization data may be used by the device to translate first field sensor data from the second sensor. The method may also include collecting second calibration sensor data from the first sensor and generating second characterization data based on the second calibration sensor data after the first characterization data is provided. The method may further include providing the second characterization data to be pushed to the device. The second characterization data may be used by the device to translate second field sensor data from the second sensor.

In some examples, a system for sensor degradation compensation may be described. The system may include a transceiver and a processor device. The transceiver may be configured to receive first sensor characterization data based on first calibration sensor data output by a first sensor and to receive second sensor characterization data based on second calibration sensor data output by the first sensor. The processor device may be communicatively coupled to the transceiver. The processor device may be configured to apply the first sensor characterization data to first field sensor data received from a second sensor. The processor may be further configured to apply the second sensor characterization data to second field sensor data received from the second sensor. In some embodiments, the second sensor characterization data and the second field sensor data may be received by the transceiver after the first sensor characterization data is applied to the first field sensor data.

In some examples, a non-transitory computer-readable medium is described that includes computer-readable instructions stored thereon that are executable by a processor to perform or control performance of operations of sensor degradation compensation. The operations may include generating first characterization data of a first sensor based on first calibration sensor data output by the first sensor, the first sensor from either a first batch of sensors manufactured at a first time or a second batch of sensors manufactured at a second time after the first time. The operations may also include providing the first characterization data to be pushed to multiple devices. Each of the multiple devices may be associated with one sensor from the second sensors of the first batch of sensors and the second batch of sensors. The first characterization data may be used by the devices to translate field sensor data from the second sensors. The operations may further include collecting second calibration sensor data output by the first sensor after providing the first characterization data to be pushed to the devices. The operations may also include generating second characterization data based on the second calibration sensor data and providing the second characterization data to be pushed to the devices.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings. In the drawings:

FIG. 1a is a diagram of an example system to generate sensor characterization data;

FIG. 1b is a chart that illustrates example sensor characterization data of the system of FIG. 1a;

FIG. 2 is a diagram of an example system to update sensor characterization data;

FIG. 3 is a diagram of another example system to update sensor characterization data;

FIG. 4 is a diagram of another example system to update sensor characterization data;

FIG. 5 is a flow diagram of an example method of sensor degradation compensation;

FIG. 6 is a flow diagram of another example method of sensor degradation compensation;

FIG. 7 is a flow diagram of another example method of sensor degradation compensation; and

FIG. 8 is a block diagram illustrating an example computing device which may be used in the example systems of FIG. 2, 3, or 4, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods and systems, related to sensor degradation compensation.

Briefly stated, in some examples, a method of sensor degradation compensation is described. The method may include the selection of a first sensor from multiple sensors. First characterization data, based on first sensor data generated by the first sensor, may be generated for calibration of the first sensor. The first characterization data may be provided to a second sensor of the multiple sensors. The second sensor may be configured to be calibrated with the first characterization data. After the first characterization data is provided to the second sensor, second sensor data generated by the first sensor may be collected. Second characterization data may be generated based on the second sensor data. The second characterization data may be provided to the second sensor. The second sensor may be configured to be recalibrated with the second characterization data.

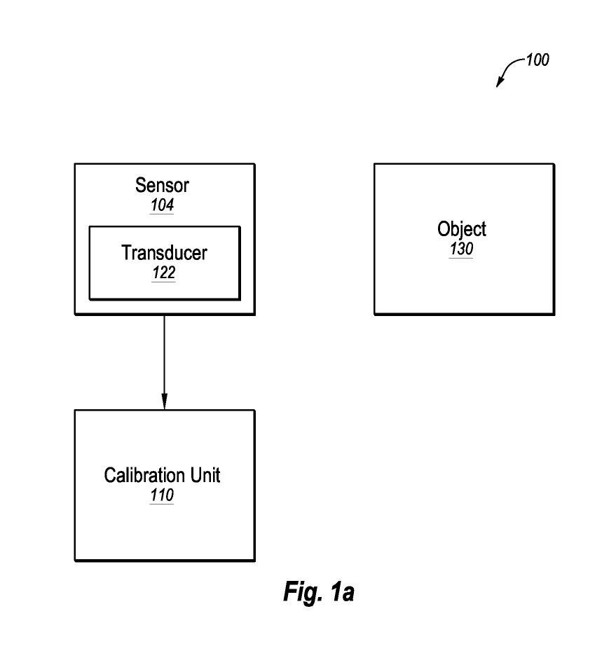

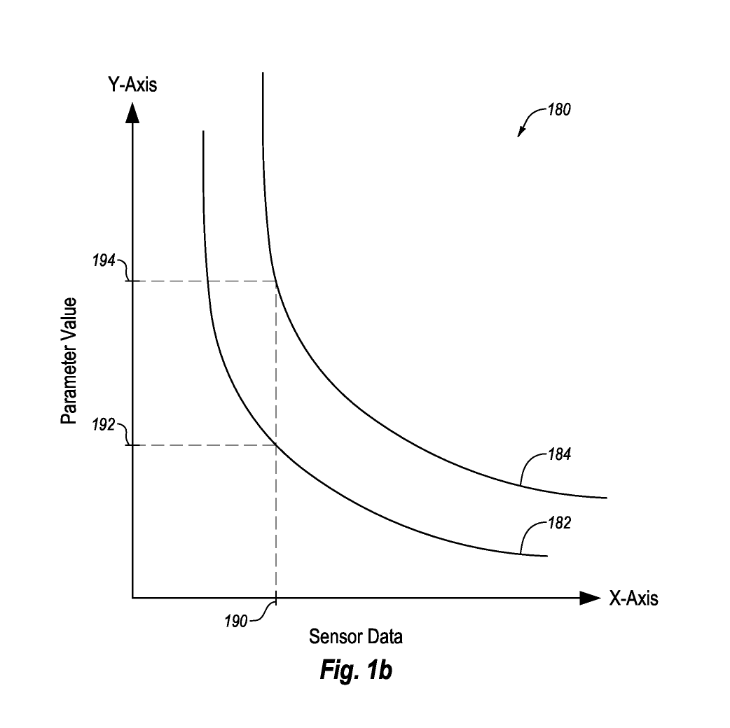

FIG. 1a is a diagram of an example system 100 to generate sensor characterization data, arranged in accordance with at least some embodiments described herein. The system 100 may include a calibration unit 110, a sensor 120, and an object 130. The calibration unit 110 may be communicatively coupled to the sensor 120. The sensor 120 may be positioned proximate to the object 130 such that the sensor 120 may measure or otherwise sense a parameter of the object.

The object 130 may include an inanimate object in a gas, liquid, or solid state. For example, the object 130 may be natural gas, water, nuclear waste, or some other type of inanimate object. In some embodiments, the object 130 may be a living organism. For example, the object 130 may be a human, an animal, an invertebrate, a reptile, a bird, or some other type of living organism.

The sensor 120 may be configured to measure or otherwise determine at least one parameter of a characteristic of the object 130. For example, the object may be an animal and the characteristics of the object 130 may be the respiration of an animal. In these and other embodiments, the parameter may include a rate of the respiration of the animal, a volume of the air transferred during respiration, a length of a breath, or some other parameter. As another example, the object 130 may be a human and the characteristics of the object 130 may be a heartbeat of a human. In these and other embodiments, the parameter may be a rate of the heartbeat, an intensity of the heartbeat, or some other parameter. As another example, the characteristic of the object 130 may be a temperature of the human and the parameter may be a value of the temperature, a change in the value, or some other parameter. Other example characteristics of a human that could be sensed may include a hydration level, blood pressure, etc.

As another example, the object may be an inanimate gas and the characteristic of the object 130 may be a concentration of the gas around the sensor 120. In these and other embodiments, the parameter may be a pressure, mole concentration, or some other parameter of the gas.

The sensor 120 may be configured to generate sensor data based on a value of the measured parameter of the object 130. In some embodiments, the sensor 120 may include a transducer 122. The transducer 122 may be configured to measure or otherwise determine a value of the parameter. The transducer 122 may be configured to measure or otherwise determine a value of a parameter by the conversion of a value of the parameter of the object 130 into the sensor data, which may be an electrical type signal. In some embodiments, the transducer 122 included in the sensor 120 may include one or more electrical circuits to generate the electrical type signal. In these and other embodiments, the electrical type signal may be a value of a voltage, a current, an impedance, a capacitance, an inductance, a conductance, a resistance, among other electrical values that may be provided by the sensor 120 to the calibration unit 110 in response to a parameter measured or otherwise determined by the sensor 120.

For example, assume the parameter measured by the sensor is a rate of a heartbeat, the sensor 120 may change a voltage provided to the calibration unit 110 based on a value of the measured parameter. For example, the sensor 120 may be configured to output a voltage equal to 0.5 volts when the heartbeat rate is 60 beats per minute and may output a voltage equal to 1.3 volts when the heartbeat rate is 120 beats per minute. As another example, the sensor 120 may change a capacitance, inductance, resistance, or some other value of the sensor 120 as seen by the calibration unit 110 based on the value of the parameter measured by the sensor 120.

In some embodiments, the output of the transducer 122 in the sensor 120 may be the sensor data provided to the calibration unit 110. Alternately or additionally, the sensor 120 may include other devices, such as a processor device, electrical circuitry, or some other device, configured to condition, change, or otherwise alter the output of the transducer 122 to generate the sensor data.

The calibration unit 110 may be configured to receive the sensor data from the sensor 120. Based on the sensor data, the calibration unit 110 may be configured to generate characterization data for calibration of the sensor 120. To generate the characterization data, the calibration unit 110 may obtain a value of the parameter of the object 130 measured by the sensor 120 and correlate the value of the parameter of the object 130 with the sensor data received from the sensor 120.

In some embodiments, to obtain the value of the parameter of the object, the calibration unit 110 may include or be embodied as a sensor that measures or otherwise determines a value of the parameter of the object 130. Alternately or additionally, to obtain the value of the parameter of the object, the calibration unit 110 may receive an indication of the value of the parameter of the object 130 from another device.

The calibration unit 110 may correlate a value of the parameter of the object 130 with the sensor data to determine the characterization data for the sensor 120. In some embodiments, the sensor data and the value of the parameter may include a linear relationship. In these and other embodiments, the characterization data may include a linear equation that translates the sensor data to the value of the parameter of the object 130.

For example, assume that the linear equation to translate the sensor data to the value of the parameter of the object 130 is Y=80*X, where Y is the value of the parameter and X is the sensor data. Further assume that the sensor data is a voltage and that the parameter of the object is a heartbeat rate of a human. In these and other embodiments, when the sensor data is 0.75 volts, the heartbeat rate may be 60 and when the sensor data is 1.5 volts, the heartbeat rate may be 120. Generally, the provision of the characterization data to a device such that the characterization data may be used to translate the sensor data to the value of the parameter may be referred to herein as a calibration of the sensor 120.

In some embodiments, the correlation between the sensor data and the value of the parameter of the object 130 may be represented by a first, second, third, fourth or fifth degree polynomial equation or some other polynomial equation. Alternately or additionally, the correlation between the sensor data and the value of the parameter of the object 130 may be represented by some other type of equation, such as logarithmic equation, stepwise equation, or other type of equation.

In some embodiments, the characterization data may be provided by way of a look-up table that includes multiple values of sensor data and corresponding values of the parameter. For example, the look-up table may be formed such that sensor data is used to locate fields in the look-up table that include the values of the parameter that correspond with the respective sensor data.

After a period of time, the sensor 120 may generate different sensor data for the same value of the parameter. The change in the sensor data generated by the sensor 120 may be a result of a change in the transducer 122 due to aging or other effects of use of the sensor 120 to measure the parameter of the object. In these and other embodiments, the sensor 120 may again, after the period of time, provide the sensor data to the calibration unit 110. The calibration unit 110 may generate second characterization data that better represents the correlation between the sensor data and the value of the parameter of the object 130 at the current time than previous characterization data. As a result, in some embodiments, the characterization data may describe a first relationship between the value of the parameter and the sensor data from the sensor 120 at a first time and the second characterization data may describe a second relationship between the value of the parameter and the sensor data from the sensor 120 at the second time that is after the first time.

Generally, the provision of the newer characterization data such that the newer characterization data may be used to translate the sensor data to the value of the parameter may be referred to herein as a recalibration of the sensor 120.

In some embodiments, the period of time before the sensor 120 may generate different sensor data for the same value of the parameter may depend on one or more factors. Some factors may include the object 130 that is measured or otherwise determined, a value of the parameter of the object 130 that is measured or otherwise determined, the construction of the sensor 120, and the conditions in which the sensor 120 operates, among other factors.

As mentioned previously, in some embodiments, the sensor 120 may include other devices, such as a processor device, electrical circuitry, or some other device, configured to condition, change, or otherwise alter the output of the transducer 122 to generate the sensor data. In these and other embodiments, the other devices included in the sensor 120 may be configured to receive the characterization data from the calibration unit 110 or some other device that received the characterization data from the calibration unit 110. After the reception of the characterization data, the sensor 120 may be considered a calibrated sensor. By way of the characterization data, the other devices in the sensor 120 may condition, change, and/or alter the output of the transducer 122 such that the sensor data output by the sensor 120 may be the value of the parameter. In these and other embodiments, when the sensor 120 does not include the characterization data, the sensor data output by the sensor 120 may be the output of the transducer 122.

Modifications, additions, or omissions may be made to FIG. 1a without departing from the scope of the present disclosure. For example, in some embodiments, the system 100 may include an additional sensor or device configured to measure or otherwise determine the parameter of the object 130 and provide the measurement to the calibration unit 110.

FIG. 1b is a chart 180 that illustrates example sensor characterization data of the system 100 of FIG. 1a, arranged in accordance with at least some embodiments described herein. The chart 180 includes a y-axis and an x-axis. The y-axis may represent a value of the parameter of the object 130. The x-axis may represent a value of the sensor data output by the sensor 120. The chart 180 may also include first characterization data 182 and second characterization data 184. The first characterization data 182 may be a polynomial that represents a correlation between the sensor data and the value of the parameter of the object 130 at a first time. The second characterization data 184 may be a polynomial that represents a correlation between the sensor data and the value of the parameter of the object 130 at a second time. The first time may be before or after the second time. The time between the first time and second time may vary. In some embodiments, the time may be 1, 3, 7, 14, 20, 60, 90, 120, 240, 365, or some other number of days. Alternately or additionally, the time may be 0.5, 1, 3, 6, 12, 18, 24, or some other number of hours.

The difference between the first characterization data 182 and the second characterization data 184 may illustrate a change over time in a characterization curve of the sensor 120 with respect to the value of the parameter. The change over time in the characterization curve of the sensor 120 may result in the generation by the sensor 120 of different sensor data for the same value of the parameter at different times.

For example, the first characterization data 182 may indicate that for a first sensor value 190 of the sensor data, the value of the parameter may be a first parameter value 192. For the first sensor value 190, the second characterization data 184 may indicate that the value of the parameter may be a second parameter value 194. In these and other embodiments, if the first characterization data 182 is used in place of the second characterization data 184, an error in the value of the parameter determined based on the sensor data may result. The error that may result may be equal to a difference between the first parameter value 192 and the second parameter value 194. By use of the second characterization data 184 in place of the first characterization data 182, the accuracy of the value of the parameter measured by the sensor 120 may be increased. Modifications, additions, or omissions may be made to FIG. 1b without departing from the scope of the present disclosure.

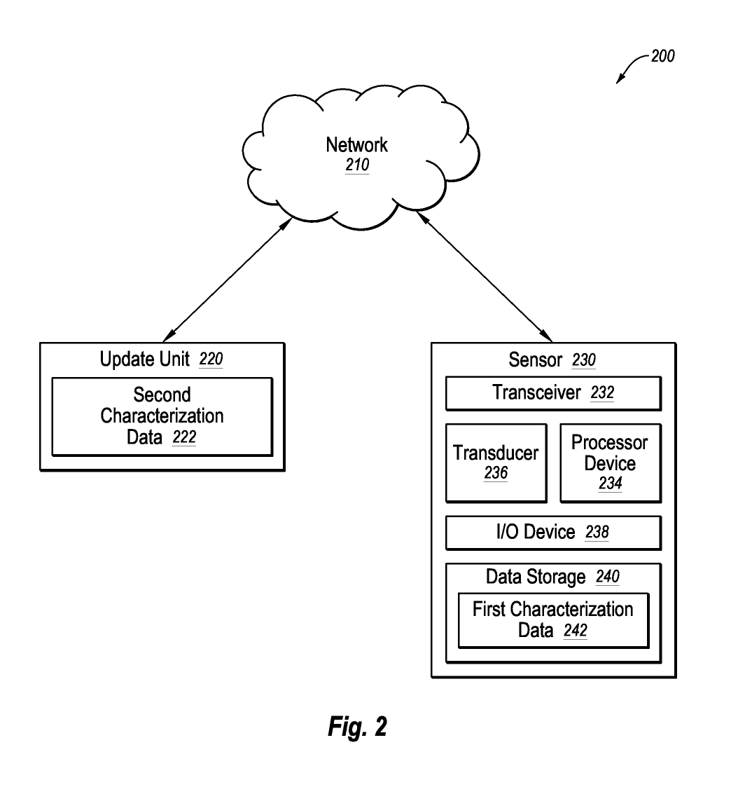

FIG. 2 is a diagram of an example system 200 to update sensor characterization data, arranged in accordance with at least some embodiments described herein. The system 200 may include a network 210, an update unit 220, and a sensor 230. The network 210, the update unit 220, and the sensor 230 may be communicatively coupled. In general, the system 200 may operate to recalibrate the sensor 230 over the network 210 by use of the second characterization data 222 provided by the update unit 220. The second characterization data 222 may be based on sensor data generated by a sensor other than the sensor 230.

In general, the network 210 may include one or more wide area networks (WANs) and/or local area networks (LANs) that enable the update unit 220 and the sensor 230 to communicate with each other. In some embodiments, the network 210 may include the Internet, which may include a global internetwork formed by logical and physical connections between multiple WANs and/or LANs. Alternately or additionally, the network 210 may include one or more cellular RF networks and/or one or more wired and/or wireless networks such as, but not limited to, 802.xx networks, Bluetooth access points, wireless access points, IP-based networks, or the like. The network 210 may also include servers that enable one type of network to interface with another type of network.

The sensor 230 may be configured to measure or otherwise determine a value of a parameter of an object and to present the measurement to a user or to provide the measurement to another device over the network 210. The sensor 230 may include a transceiver 232, a processor device 234, a transducer 236, an I/O device 238, and data storage 240. The transceiver 232, the transducer 236, the I/O device 238, and the data storage 240 may be communicatively coupled with the processor device 234.

The transducer 236 may be configured to measure or otherwise determine a value of the parameter of the object that is adjacent to the sensor 230. The transducer 236 may be configured to measure or otherwise determine a value of a parameter by the conversion of the value of the parameter into the sensor data. The transducer 236 may provide the sensor data to the processor device 234.

The processor device 234 may include any suitable special-purpose or general-purpose computer, computation entity, or processor device that includes various computer hardware or software modules and may be configured to execute instructions stored on any applicable computer-readable storage media. For example, the processor device 234 may include a microprocessor, a microcontroller, a digital signal processor (DSP), an application-specific integrated circuit (ASIC), a field-programmable gate array (FPGA), or any other digital or analog circuitry configured to interpret and/or to execute program instructions and/or to process data. Although illustrated as a single processor device in FIG. 2, the processor device 234 may include any number of processor devices.

The processor device 234 may be configured to receive the sensor data from the transducer 236. The processor device 234 may be further configured to apply first characterization data 242 stored in the data storage 240 to the sensor data to determine the value of the parameter of the object. In these and other embodiments, the application of the first characterization data 242 to the sensor data may translate the sensor data to the value of the parameter of the object by way of the first characterization data 242. In general, the first characterization data 242 may be configured to calibrate the sensor 230 such that the sensor 230 may provide more accurate measurements/determinations of the value of parameters of an object.

In some embodiments, the first characterization data 242 may be provided by way of an equation that receives the sensor data as an input and outputs the value of the parameter of the object. In these and other embodiments, the processor device 234 may access the first characterization data 242 in the data storage 240. By the use of the first characterization data 242, the processor device 234 may determine the value of the parameter of the object based on the sensor data.

In some embodiments, the first characterization data 242 may be provided by way of a look-up table that includes multiple sensor data values and corresponding values of the parameter of the object. In these and other embodiments, the processor device 234 may access the look-up table in the data storage 240 and obtain the value of the parameter of the object that corresponds with the sensor data.

In some embodiments, the processor device 234 may be further configured to configure the value of the parameter of the object for presentation by the I/O device 238. In these and other embodiments, the processor device 234 may format, edit, or otherwise manipulate the value of the parameter of the object for presentation and may send the manipulated value of the parameter to the I/O device 238.

The data storage 240 may include computer-readable storage media or one or more computer-readable storage mediums for the storage of computer-executable instructions or data structures thereon. Such computer-readable storage media may be any available media that may be accessed by a general-purpose or special-purpose computer, such as the processor device 234. By way of example, and not limitation, such computer-readable storage media may include non-transitory computer-readable storage media that includes random access memory (RAM), read-only memory (ROM), electrically erasable programmable read-only Memory (EEPROM), compact disc read-only memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. The data storage 240 may include the first characterization data 242.

In some embodiments, the first characterization data 242 may be based on sensor data generated by a sensor other than the sensor 230. In these and other embodiments, the other sensor may be stimulated with the parameter of the object and the sensor data that results may be used to generate the first characterization data 242. In these and other embodiments, the system 100 of FIG. 1 may be an example of a system that may be used to generate the first characterization data 242.

In some embodiments, the other sensor used to generate the first characterization data 242 may be manufactured at approximately the same time as the sensor 230. In some embodiments, the first characterization data 242 may be manufactured at approximately the same time as the sensor 230 when the time between the manufacture is less than one month, less than two weeks, less than one week, less than 6, 5, 4, 3, or 2 days. In some embodiments, the other sensor and the sensor 230 may be manufactured on the same day. In some embodiments, the transducer in the other sensor and the transducer 236 of the sensor 230 may be manufactured on the same silicon wafer or on the same die on the same silicon wafer. Alternately or additionally, the transducer in the other sensor and the transducer 236 of the sensor 230 may be manufactured on the same day or at approximately the same time. In some embodiments, such sensors and/or components thereof may be manufactured in the same batch or product run, within a few months or less of each other.

In some embodiments, the first characterization data 242 may be provided to the sensor 230 before the sensor 230 is deployed into the field and leaves its place of manufacture. In these and other embodiments, the first characterization data 242 may be provided to the sensor 230 by directly programming the data storage 240 with the first characterization data 242. Alternately or additionally, the first characterization data 242 may be provided to the sensor 230 over a local area network at the place of manufacture by use of the transceiver 232.

Alternately or additionally, the first characterization data 242 may be provided to the sensor 230 over the network 210. In these and other embodiments, the first characterization data 242 may be provided to the sensor 230 after power is applied to the sensor 230 and the sensor 230 is connected to the network.

I/O device 238 may be configured to receive the value of the parameter from the processor device 234 and to present the value of the parameter. In some embodiments, the I/O device 238 may present the value of the parameter by visual display, audio broadcast, vibration, some combination thereof, or by some other form of presentation. In some embodiments, the I/O device 238 may include one or more I/O devices. For example, in some embodiments, the I/O device 238 may be a display and a speaker.

The transceiver 232 may include hardware, software, or both hardware and software that is configured to transmit and receive communications over the network 210. In some embodiments, the transceiver 232 may transmit and receive communications over the network 210 under the direction of the processor device 234. In these and other embodiments, the processor device 234 may direct the transceiver 232 to perform the appropriate procedures for communication over the network 210.

The update unit 220 may be configured to provide second characterization data 222 to the sensor 230 over the network 210. The second characterization data 222 may be based on sensor data generated by the other sensor that generated the sensor data used to generate the first characterization data 242. Thus, the first characterization data 242 and the second characterization data 222 may be based on sensor data generated by the same other sensor that is not the sensor 230. In these and other embodiments, the system 100 of FIG. 1 may be an example of a system that may be used to generate the second characterization data 222.

In some embodiments, the second characterization data 222 may be generated and provided to the sensor 230 to help to compensate for a change in the characterization curve of the transducer 236. In these and other embodiments, the second characterization data 222 may be generated after the first characterization data 242 is provided to the sensor 230. As a result, the sensor data output by the other sensor that is used to generate the second characterization data 222 may be generated by the other sensor after the first characterization data 242 is provided to the sensor 230.

In some embodiments, the period of time before a change in the characterization curve occurs, and thus the second characterization data 222 is generated, may depend on one or more factors. Some factors may include the object that is measured, a value of the parameter of the object that is measured, the construction of the sensor 230, and the conditions in which the sensor 230 operates, among other factors. In some embodiments, the period of time may be 1, 2, 4, 6, 7, 14, 30, 60, 120, or 200 days or some other number of days or timespan. In some embodiments, the period of time may be a number of hours less than one day.

In some embodiments, the other sensor that is used to generate the second characterization data 222 may be subjected to similar conditions as the sensor 230. In this manner, changes in the characterization curves, etc., amongst the sensors can be considered to be similar or analogous for compensation/adjustment purposes. Alternately or additionally, the other sensor may be subjected to different conditions than the sensor 230.

After the second characterization data 222 is generated, the second characterization data 222 may be provided to the update unit 220. The update unit 220 may provide the second characterization data 222 to the network 210 for communication with the sensor 230.

The transceiver 232 may be configured to receive the second characterization data 222 over the network 210 from the update unit 220. The transceiver 232 may provide the second characterization data 222 to the processor device 234. In some embodiments, the processor device 234 may store the second characterization data 222 in the data storage 240. In some embodiments, the second characterization data 222 may replace the first characterization data 242. Alternately or additionally, the second characterization data 222 may be stored along with the first characterization data 242. After storage of the second characterization data 222 in the data storage 240, the processor device 234 may be configured to use the second characterization data 222 to translate the sensor data from the transducer 236. By the storage of the second characterization data 222 in the data storage 240, the sensor 230 may be recalibrated.

In some embodiments, the sensor 230 may request the second characterization data 222 from the update unit 220 after a period of time of operation. Alternately or additionally, the sensor 230 may report a current time period of operation to the update unit 220. After a particular time period of operation, the update unit 220 may be configured to provide the second characterization data 222 to the sensor 230. In these and other embodiments, the second characterization data 222 may be configured to compensate for the change in the characterization curve that results from the passage of the particular time period.

Alternately or additionally, the update unit 220 may push the second characterization data 222 to the sensor 230 and the other sensors of the batch of sensors after a particular time period. In these and other embodiments, the second characterization data 222 may be configured to compensate for the change in the characterization curve that results from the passage of the particular time period.

Alternately or additionally, the second characterization data 222 may be generated based on a particular change in the characterization curve of the other sensor. For example, the characterization curve of the other sensor may be tested periodically or otherwise repeatedly to determine how much the characterization curve of the other sensor has varied from the first characterization data 242. When the change is more than a threshold, the other sensor may be used to generate the second characterization data 222. The second characterization data 222 may be provided to the update unit 220. The update unit 220 may be configured to push the second characterization data 222 to the sensor 230 and the other sensors of the batch of sensors. In these and other embodiments, the threshold may be based on an error margin that may be tolerated for the value of the parameter presented or provided by the sensor 230. In these and other embodiments, the change in the characterization curve of the other sensor may be periodically monitored after the generation of the second characterization data 222 and additional characterization data may be generated and provided to the sensor 230 and the other sensors of the batch of sensors.

An example of the operation of the system 200 follows. A manufacturer may produce a batch of sensors that includes the sensor 230. One of the sensors of the batch may be selected. The selected sensor may be used to generate the first characterization data 242 to calibrate the batch of sensors. Each of the sensors in the batch, which includes the sensor 230, may be calibrated with the first characterization data 242 by programming the data storage of each of the sensors. The sensor 230 with the first characterization data 242 may be shipped and distributed. The selected sensor may be subject to conditions similar to the sensor 230 when the sensor 230 is in operation in the field. The selected sensor may be tested periodically or otherwise repeatedly to determine changes in the characterization curve of the selected sensor. When the determined change is above a threshold, the second characterization data 222 may be generated by way of the selected sensor. The second characterization data 222 may be provided to the sensor 230 and other sensors of the batch of sensors over the network 210 to recalibrate these sensors by the update of the characterization data of these sensors. Additional characterization data may be provided to the sensor 230 and the other sensors of the batch of sensors periodically based on additional detected changes in the characterization curve of the selected sensor. In this manner, compensation may be made for changes in the characterization curve of the sensor 230 while the sensor 230 is in the field without knowledge of how the characterization curve will change before the sensor 230 is sent into the field.

Modifications, additions, or omissions may be made to FIG. 2 without departing from the scope of the present disclosure. For example, in some embodiments, the update unit 220 may be part of the network 210. In these and other embodiments, the second characterization data 222 may be provided to the network 210 and then distributed to the sensors 230.

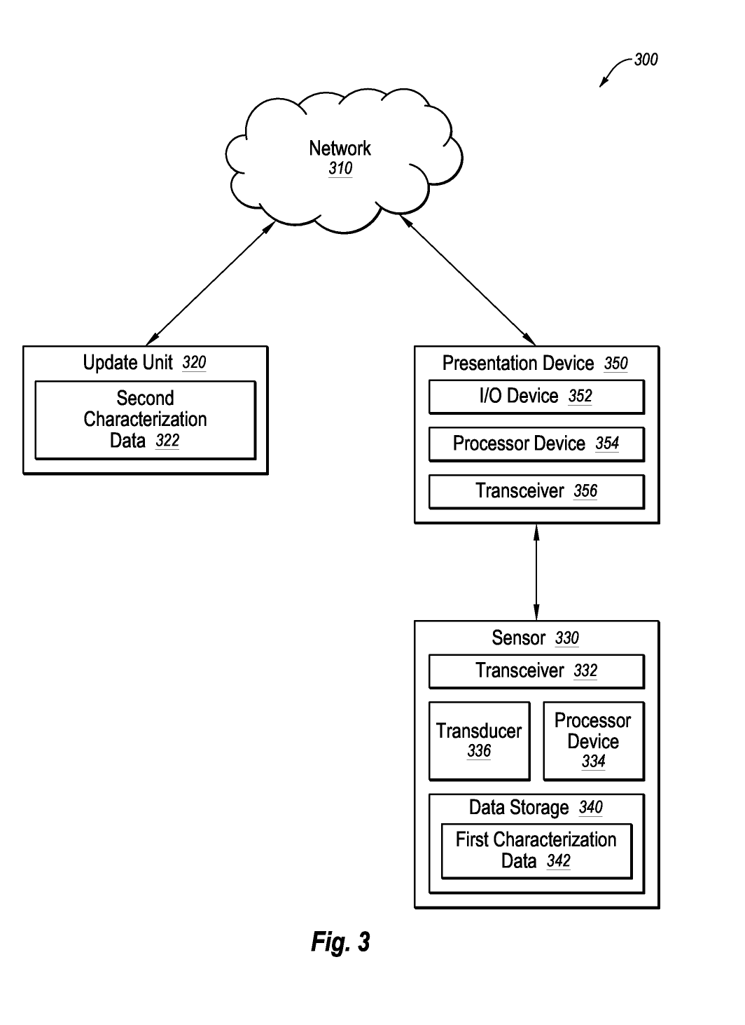

FIG. 3 is a diagram of another example system 300 to update sensor characterization data, arranged in accordance with at least some embodiments described herein. The system 300 may include a network 310, an update unit 320, a sensor 330, and a presentation device 350. The network 310, the update unit 320, the sensor 330, and presentation device 350 may be communicatively coupled. In general, the system 300 may operate to recalibrate the sensor 330 over the network 310 by the application of the second characterization data 322 provided by the update unit 320, such as generally described with respect to the system 200 of FIG. 2. In the system 300, the sensor 330 may communicate with the network 310 by way of the presentation device 350 and may provide a value of a parameter of an object measured by the sensor 330 for presentation by the presentation device 350.

In general, the network 310 may include one or more wide area networks (WANs) and/or local area networks (LANs) that enable the update unit 320 and the presentation device 350 to communicate with each other. In some embodiments, the network 310 may include the Internet, which includes a global internetwork formed by logical and physical connections between multiple WANs and/or LANs. Alternately or additionally, the network 310 may include one or more cellular RF networks and/or one or more wired and/or wireless networks such as, but not limited to, 802.xx networks, Bluetooth access points, wireless access points, IP-based networks, or the like. The network 310 may also include servers that enable one type of network to interface with another type of network.

The sensor 330 may be configured to measure the value of the parameter of the object and to provide the measurement to the presentation device 350. The presentation device 350 may present the value of the parameter to a user or may provide the measurement to another device over the network 310. The sensor 330 may include a transceiver 332, a processor device 334, a transducer 336, and data storage 340. The transceiver 332, the transducer 336, and the data storage 340 may be communicatively coupled with the processor device 334.

The transducer 336 may be configured to measure a value of the parameter of the object that is adjacent to the sensor 330. The transducer 336 may be configured to measure a value of a parameter by the conversion of the value of the parameter into the sensor data. The transducer 336 may provide the sensor data to the processor device 334.

In some embodiments, the processor device 334 and the data storage 340 may be configured in a manner analogous to or different from the processor device 234 and the data storage 240 of FIG. 2.

In some embodiments, the processor device 334 may be configured to receive the sensor data from the transducer 336. The processor device 334 may be further configured to apply first characterization data 342 stored in the data storage 340 to the sensor data to determine the value of the parameter of the object. In these and other embodiments, the application of the first characterization data 342 to the sensor data may translate the sensor data to the value of the parameter of the object by way of the first characterization data 342. In general, the first characterization data 342 may be configured to calibrate the sensor 330 such that the sensor 330 may provide more accurate measurements of the value of parameters of an object. The first characterization data 342 and the second characterization data 322 may be generated in an analogous manner as described previously with respect to FIGS. 1 and 2. The processor device 334 may be further configured to provide the value of the parameter of the object to the transceiver 332 to provide to the presentation device 350.

The transceiver 332 may include hardware, software, or both hardware and software that is configured to transmit and receive communications with the presentation device 350. In some embodiments, the transceiver 332 may transmit and receive wireless or wired communications with the presentation device 350 under the direction of the processor device 334. In these and other embodiments, the processor device 334 may direct the transceiver 332 to perform the appropriate procedures for communication with the presentation device 350.

The presentation device 350 may be configured to receive the value of the parameter of the object from the sensor 330. The presentation device 350 may include a smart phone, tablet computer, smart watch, cellular phone, desktop computer, laptop computer, server, among other electronic equipment. In some embodiments, the presentation device 350 may include an I/O device 352, a processor device 354, and a transceiver 356. The I/O device 352 and the transceiver 356 may be communicatively coupled with the processor device 354.

The transceiver 356 may include hardware, software, or both hardware and software that is configured to transmit and receive communications with the sensor 330 and with the network 310. In some embodiments, the transceiver 356 may transmit and receive communications with the sensor 330 and with the network 310 under the direction of the processor device 354. The communications may be wireless communications or wired communications. In these and other embodiments, the processor device 354 may direct the transceiver 356 to perform the appropriate procedures for communication with the network 310 and the sensor 330. The transceiver 356 may be configured to receive the value of the parameter of the object from the sensor 330 and provide the value of the parameter of the object to the processor device 354.

The processor device 354 may be configured to receive the value of the parameter of the object from the transceiver 356. In general, the processor device 354 may be configured in a manner analogous to or different from the processor device 234 of FIG. 2.

The processor device 354 may be further configured to configure the value of the parameter of the object for presentation by the I/O device 352. In these and other embodiments, the processor device 354 may format, edit, or otherwise manipulate the value of the parameter of the object for presentation and may send the manipulated value of the parameter to the I/O device 352.

The I/O device 352 may be configured to receive the value of the parameter from the processor device 354 and to present the value of the parameter. In some embodiments, the I/O device 352 may present the value of the parameter by visual display, audio broadcast, vibration, some combination thereof, or some other form of presentation. In some embodiments, the I/O device 352 may include one or more I/O devices. For example, in some embodiments, the I/O device 352 may be a display and a speaker.

As discussed previously, the presentation device 350 may be further configured to request and/or receive the second characterization data 322 from the update unit 320 and to provide the second characterization data 322 to the sensor 330. In these and other embodiments, the sensor 330, by way of the processor device 334 and the transceiver 332, may send sensor identification data to the presentation device 350. The presentation device 350, by way of the processor device 354 and the transceiver 356, may relay the sensor identification data over the network to the update unit 320.

The update unit 320 may be configured to provide the second characterization data 322 over the network 310 to the presentation device 350 to relay to the sensor 330. In these and other embodiments, the update unit 320 may select the appropriate second characterization data 322 based on the sensor identification data provided by the presentation device 350. For example, the update unit 320 may identify another sensor used to generate the first characterization data 342 by way of the sensor identification data. The update unit 320 may select the second characterization data 322 to provide to the presentation device 350 based on sensor data from the other sensor. As another example, the update unit 320 may use the sensor identification data to determine an amount of time of use of the sensor 330. The update unit 320 may select the second characterization data 322 based on the other sensor and the amount of time of use of the sensor 330. After the selection of the second characterization data 322, the update unit 320 may provide the second characterization data 322 to the presentation device 350 by way of the network 310. The presentation device 350 may then provide the second characterization data 322 to the sensor 330.

The sensor 330 may store the second characterization data 322 in the data storage 340. The transducer 336 may again measure a value of a parameter to generate sensor data. The processor device 334 may translate the sensor data by way of the second characterization data 322 stored in the data storage 340 and provide the value of the parameter that results from the translation to the presentation device 350.

An example of the system 300 follows. Assume that the presentation device 350 is a smart phone. The sensor 330 may communicate with the presentation device 350 by way of a wireless communication standard, such as IEEE 802.15 that uses short-range radio frequencies. The sensor 330 may measure the value of parameters and provide the measured values to the smart phone. The smart phone, by way of a software application that is run on the processor device 354, may present the measured value on a display of the smart phone. The smart phone may communicate with the update unit 320 over the network 310 and may provide the identification of the sensor 330 to the update unit 320. The smart phone may communicate with the network 310 by way of cellular communications or the IEEE 802.11 wireless standard. Based on the sensor identification data, the update unit 320 may push the second characterization data 322 to the smart phone to relay to the sensor 330 when the second characterization data 322 becomes available. After reception of the second characterization data 322, the smart phone may communicate with the sensor 330 and provide the second characterization data 322 to the sensor 330. The sensor 330 may use the second characterization data 322 to translate future sensor data to a value of the parameter and provide the value of the parameter to the smart phone.

Modifications, additions, or omissions may be made to FIG. 3 without departing from the scope of the present disclosure. For example, in some embodiments, the sensor 330 may be configured to communicate with the network 310. In these and other embodiments, the sensor 330 may directly receive the second characterization data 322 from the network 310. Alternately or additionally, the sensor 330 may not include the data storage 340 and the first characterization data 342. In these and other embodiments, the presentation device 350 may include the data storage 340 and the first characterization data 342. The sensor 330 may be configured to provide the sensor data to the presentation device 350. The presentation device 350 may apply the first and second characterization data to the sensor data to generate the value of the parameter. In these and other embodiments, the sensor 330 may be associated with the presentation device 350. The association of the sensor 330 and the presentation device 350 may be a result of the presentation device's 350 wireless reception of sensor data from the sensor 330 and the application of the first characterization data and/or second characterization data to the sensor data.

In some embodiments, the presentation device 350 may be communicatively coupled with multiple sensors. In these and other embodiments, the presentation device 350 may communicate information to and from each of the sensors with respect to the network 310 and may present values of parameters from each of the sensors.

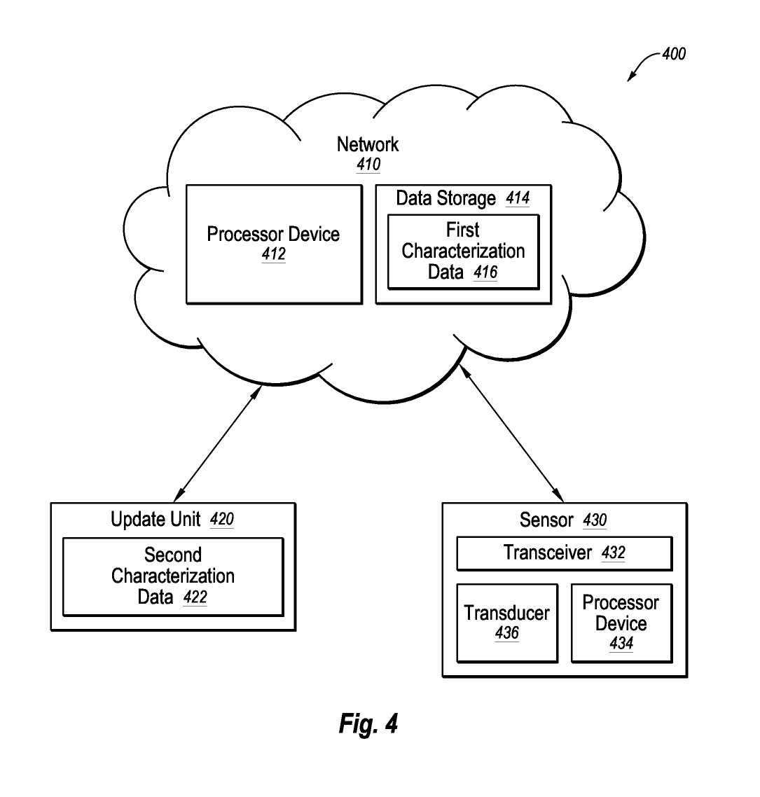

FIG. 4 is a diagram of another example system 400 to update sensor characterization data, arranged in accordance with at least some embodiments described herein. The system 400 may include a network 410, an update unit 420, and a sensor 430. The network 410, the update unit 420, and the sensor 430 may be communicatively coupled. In general, the system 400 may operate to recalibrate sensor data from the sensor 430 over the network 410 by application of second characterization data 422 provided by the update unit 420, such as generally described with respect to the system 200 of FIG. 2. In the system 400, the sensor 430 may communicate with the network 410 and may provide sensor data to the network for the application of the first characterization data 416 or the second characterization data 422.

In general, the network 410 may include one or more wide area networks (WANs) and/or local area networks (LANs) that enable the network 410 to communicate with the update unit 420 and the sensor 430. In some embodiments, the network 410 may include the Internet, which may include a global internetwork formed by logical and physical connections between multiple WANs and/or LANs. Alternately or additionally, the network 410 may include one or more cellular RF networks and/or one or more wired and/or wireless networks such as, but not limited to, 802.xx networks, Bluetooth access points, wireless access points, IP-based networks, or the like. The network 410 may also include servers that enable one type of network to interface with another type of network.

The network 410 may further include a processor device 412 and a data storage 414 that includes the first characterization data 416. In some embodiments, the processor device 412 and the data storage 414 may be configured in a manner analogous to or different from the processor device 234 and the data storage 240 of FIG. 2.

The sensor 430 may be configured to measure (or otherwise determine) the value of the parameter of the object and to provide the measurement to the processor device 412 in the network 410. The processor device 412 may provide the measurement to another device over the network 410. The sensor 430 may include a transceiver 432, a processor device 434, and a transducer 436. The transceiver 432 and the transducer 436 may be communicatively coupled with the processor device 434.

The transducer 436 may be configured to measure or otherwise determine a value of the parameter of the object that is adjacent to the sensor 430. The transducer 436 may be configured to measure or otherwise determine a value of a parameter by the conversion of the value of the parameter into the sensor data. The transducer 436 may provide the sensor data to the processor device 434.

The processor device 434 may be configured to receive the sensor data from the transducer 436 and to provide the sensor data to the transceiver 432. The transceiver 432 may include hardware, software, or both hardware and software that is configured to transmit and receive communications with the network 410. In some embodiments, the transceiver 432 may transmit and receive communications with the network 410 under the direction of the processor device 434. In these and other embodiments, the processor device 434 may direct the transceiver 432 to perform appropriate procedures for communication with the network 410 and to provide the sensor data to the processor device 412 in the network 410.

In some embodiments, the processor device 412 may be configured to receive the sensor data from the transceiver 432. The processor device 412 may be further configured to apply first characterization data 416 stored in the data storage 414 to the sensor data to determine the value of the parameter of the object. In these and other embodiments, the application of the first characterization data 416 to the sensor data may translate the sensor data to the value of the parameter of the object by way of the first characterization data 416. In general, the first characterization data 416 may be configured to calibrate the sensor data such that more accurate measurements of the value of parameters of an object may be achieved. The first characterization data 416 and second characterization data 422 may be generated in an analogous manner as described previously with respect to FIGS. 1 and 2.

The processor device 412 may be further configured to request and/or receive the second characterization data 422 from the update unit 420 for use in translation of the sensor data from the sensor 430. In these and other embodiments, the sensor 430, by way of the processor device 434 and the transceiver 432 may send sensor identification data to the processor device 412. The processor device 412 may relay the sensor identification data over the network to the update unit 420.

The update unit 420 may be configured to provide the second characterization data 422 to the processor device 412. In these and other embodiments, the update unit 420 may select the appropriate second characterization data 422 based on the sensor identification data provided by the processor device 412. For example, the update unit 420 may identify, based on the sensor identification data, another sensor used to generate the first characterization data 416. The update unit 420 may select the second characterization data 422 to provide to the processor device 412 based on sensor data from the other sensor. As another example, the update unit 420 may use the sensor identification data to determine an amount of time of use of the sensor 430. The update unit 420 may select the second characterization data 422 based on the other sensor and the amount of time of use of the sensor 430. After the selection of the second characterization data 422, the update unit 420 may provide the second characterization data 422 to the processor device 412.

Modifications, additions, or omissions may be made to FIG. 4 without departing from the scope of the present disclosure. For example, in some embodiments, the system 400 may include a presentation device similar to the presentation device 350 of FIG. 3. In these and other embodiments, the sensor 430 may communicate the sensor data to the presentation device. The presentation device may provide the sensor data to the processor device 412 for application of the first characterization data 416 or the second characterization 422 to generate the value of the parameter. The processor device 412 may send the value of the parameter to the presentation device for presentation of the value of the parameter.

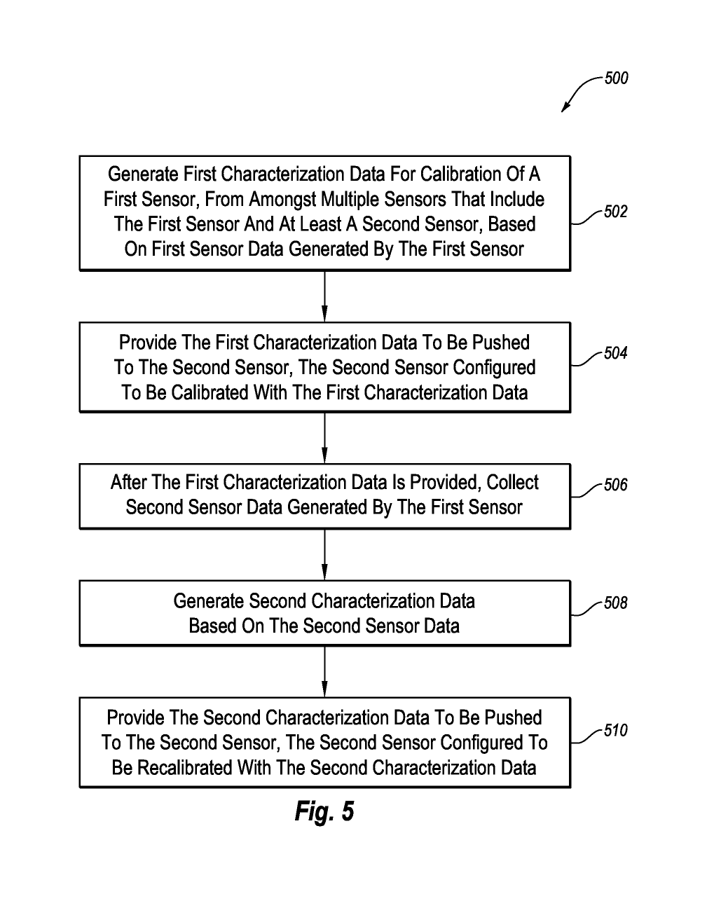

FIG. 5 illustrates an example flow diagram of a method 500 of sensor degradation compensation, arranged in accordance with at least some embodiments described herein. The method 500 may be performed in whole or in part by, e.g., the systems 100, 200, 300, or 400 of FIGS. 1, 2, 3, and 4 and/or variation(s) thereof. The method 500 includes various operations, functions, or actions as illustrated by one or more of blocks 502, 504, 506, 508, and/or 510. The method 500 may begin at block 502.

In block 502 [Generate First Characterization Data For Calibration Of A First Sensor, From Amongst Multiple Sensors That Include The First Sensor And At Least A Second Sensor, Based On First Sensor Data Generated By The First Sensor], first characterization data may be generated for calibration of a first sensor, from amongst multiple sensors that include the first sensor and at least a second sensor, based on the first sensor data generated by the first sensor. In some embodiments, a calibration unit, such as the calibration unit 110 of FIG. 1a, may generate the first characterization data.

In block 504 [Provide The First Characterization Data To Be Pushed To The Second Sensor, The Second Sensor Configured To Be Calibrated With The First Characterization Data], the first characterization data may be provided to be pushed to the second sensor. The second sensor may be configured to be calibrated with the first characterization data. In some embodiments, a calibration unit, such as the calibration unit 110 of FIG. 1a, may provide the first characterization data.

In block 506 [After The First Characterization Data Is Provided, Collect Second Sensor Data Generated By The First Sensor], after the first characterization data is provided, second sensor data generated by the first sensor may be collected. In some embodiments, a calibration unit, such as the calibration unit 110 of FIG. 1a, may collect second sensor data.

In block 508 [Generate Second Characterization Data Based On The Second Sensor Data], second characterization data may be generated based on the second sensor data. In some embodiments, the first characterization data and the second characterization data may be in a form of an equation or a look-up table. In some embodiments, a calibration unit, such as the calibration unit 110 of FIG. 1a, may generate second characterization data.

In block 510 [Provide The Second Characterization Data To Be Pushed To The Second Sensor, The Second Sensor Configured To Be Recalibrated With The Second Characterization Data], the second characterization data may be provided to be pushed to the second sensor. The second sensor may be configured to be recalibrated with the second characterization data. In some embodiments, an update unit, such as the update unit 220 of FIG. 2, may provide the second characterization data.

For this and other processes and methods disclosed herein, the acts and operations performed in the processes and methods may be implemented in a different order. Furthermore, the outlined acts and operations are only provided as examples, and some of the acts and operations may be optional, combined into fewer acts and operations, or expanded into or supplemented with additional acts and operations without detraction from the essence of the disclosed embodiments.

For example, the method 500 may further include pushing the first characterization data to the second sensor and pushing the second characterization data to the second sensor. In these and other embodiments, the first characterization data may be pushed to the second sensor in a different manner than the second characterization data is pushed to the second sensor. In these and other embodiments, the second characterization data may be pushed to the second sensor wirelessly by way of the Internet.

As another example, the method 500 may further include collecting the first sensor data generated by the first sensor. In some embodiments, the second sensor data may be collected at a particular time period after the first sensor data is collected. In these and other embodiments, the particular time period may be based on a change over time in a characterization curve of the first sensor with respect to a sensed parameter.

In some embodiments, the sensors may be manufactured at approximately the same time. In these and other embodiments, the method 500 may further include providing the first characterization data to be pushed to the sensors. Each of the sensors may be configured to be calibrated with the first characterization data. After the first characterization data is provided, the method 500 may further include providing the second characterization data to be pushed to the sensors. Each of sensors may be configured to be recalibrated with the second characterization data.

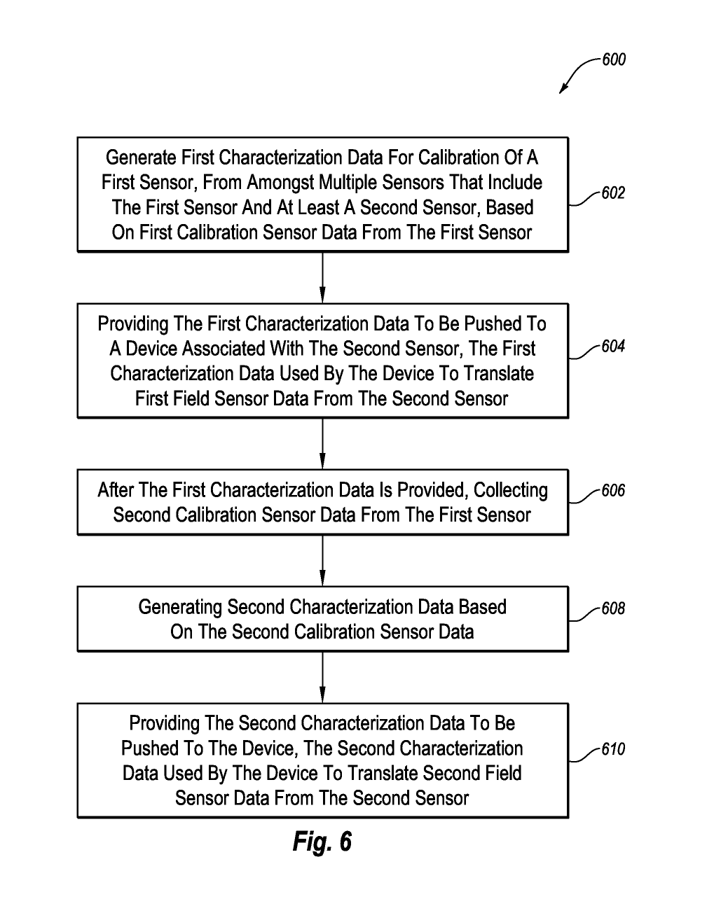

FIG. 6 illustrates an example flow diagram of a method 600 of sensor degradation compensation, arranged in accordance with at least some embodiments described herein. The method 600 may be performed in whole or in part by, e.g., the systems 100, 200, 300, or 400 of FIGS. 1, 2, 3, and 4 and/or variation(s) thereof. The method 600 includes various operations, functions, or actions as illustrated by one or more of blocks 602, 604, 606, 608, and/or 610. The method 600 may begin at block 602.

In block 602 [Generate First Characterization Data For Calibration Of A First Sensor, From Amongst Multiple Sensors That Include The First Sensor And At Least A Second Sensor, Based On First Calibration Sensor Data From The First Sensor], first characterization data for calibration of a first sensor, from amongst multiple sensors that include the first sensor and at least a second sensor, may be generated based on first calibration sensor data from the first sensor. In some embodiments, a calibration unit, such as the calibration unit 110 of FIG. 1a, may generate the first characterization data.

In block 604 [Provide The First Characterization Data To Be Pushed To A Device Associated With The Second Sensor, The First Characterization Data Used By The Device To Translate First Field Sensor Data From The Second Sensor], the first characterization data may be provided to be pushed to a device associated with the second sensor. In some embodiments, the first characterization data may be used by the device to translate first field sensor data from the second sensor. In some embodiments, the device may be associated with the second sensor by inclusion of the second sensor in the device.

In some embodiments, field sensor data may be sensor data that is collected from second sensor when the second sensor is deployed in the field. In these and other embodiments, the second sensor being deployed in the field may indicated that the second sensor has been shipped and sold in the stream of commerce such that the second sensor is being deployed by and in operation under the control of a consumer of the second sensor and not the manufacture of the second sensor. In some embodiments, an update unit, such as the update unit 220 of FIG. 2, may provide the first characterization data.

In block 606 [After The First Characterization Data Is Provided, Collect Second Calibration Sensor Data From The First Sensor], after the first characterization data is provided, second calibration sensor data from the first sensor may be collected. In some embodiments, a calibration unit, such as the calibration unit 110 of FIG. 1a, may collect second sensor data.

In block 608 [Generate Second Characterization Data Based On The Second Calibration Sensor Data], second characterization data may be generated based on the second calibration sensor data. In some embodiments, the first characterization data and the second characterization data may be in a form of an equation or a look-up table. In some embodiments, a calibration unit, such as the calibration unit 110 of FIG. 1a, may generate second characterization data.

In block 610 [Provide The Second Characterization Data To Be Pushed To The Device, The Second Characterization Data Used By The Device To Translate Second Field Sensor Data From The Second Sensor], the second characterization data may be provided to be pushed to the device. In some embodiments, the second characterization data may be used by the device to translate second field sensor data from the second sensor. In some embodiments, the second characterization data may be used by the device in place of the first characterization data to translate the second field sensor data from the second sensor. In some embodiments, an update unit, such as the update unit 220 of FIG. 2, may provide the second characterization data.

In some embodiments, the first characterization data may describe a first relationship between a sensed parameter and the first calibration sensor data from the first sensor at a first time and the second characterization data may describe a second relationship between the sensed parameter and the second calibration sensor data from the first sensor at a second time that is after the first time.

In some embodiments, the device is associated with the second sensor by inclusion of the second sensor in the device. Alternately or additionally, the device is associated with the second sensor when the device is configured to wirelessly receive the first and second field sensor data from the second sensor and apply the first characterization data to the first field sensor data and the second characterization data to the second field sensor data to generate presentation data to be presented to a user of the second sensor. In these and other embodiments, the device may include a smart phone, tablet computer, smart watch, cellular phone, desktop computer, laptop computer, server, among other devices.

In some embodiments, the method 600 may further include collecting the first calibration sensor data from the first sensor. In these and other embodiments, the second calibration sensor data may be collected at a particular time after the first calibration sensor data is collected. In some embodiments, the particular time is based on a change over time in a characterization curve of the first sensor with respect to a sensed parameter.

In some embodiments, the method 600 may further include pushing the first characterization data to the device and pushing the second characterization data to the device. In these and other embodiments, the first characterization data may be pushed to the device in a different manner than the second characterization data is pushed to the device.

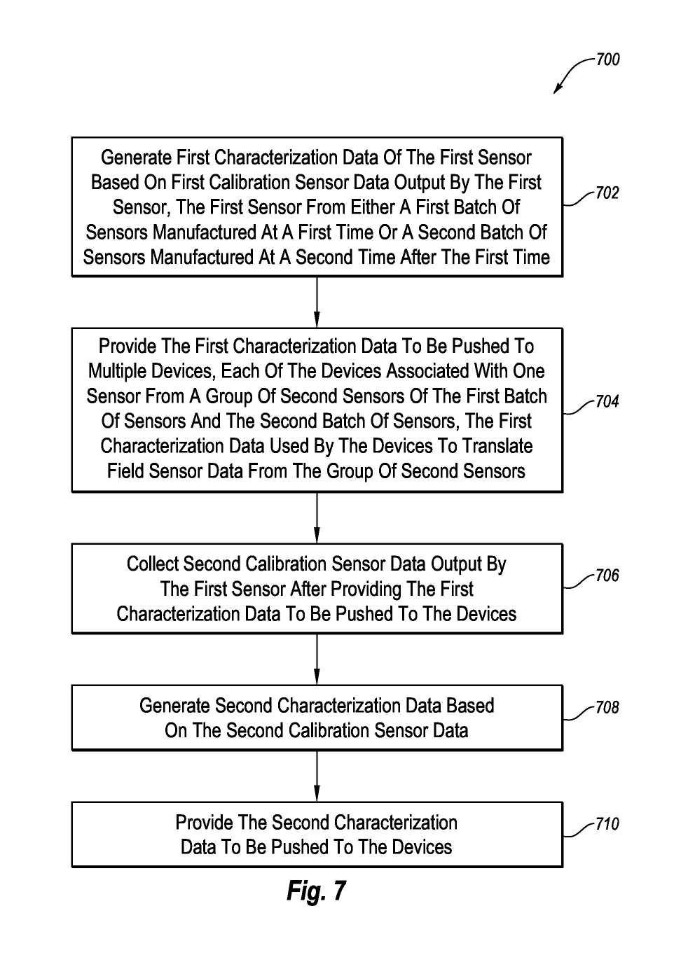

FIG. 7 illustrates an example flow diagram of a method 700 of sensor degradation compensation, arranged in accordance with at least some embodiments described herein. The method 700 may be performed in whole or in part by, e.g., the systems 100, 200, 300, or 400 of FIGS. 1, 2, 3, and 4 and/or variation(s) thereof. The method 700 includes various operations, functions, or actions as illustrated by one or more of blocks 702, 704, 706, 708, and/or 710. The method 700 may begin at block 702.

In block 702 [Generate First Characterization Data Of The First Sensor Based On First Calibration Sensor Data Output By The First Sensor, The First Sensor From Either A First Batch Of Sensors Manufactured At A First Time Or A Second Batch Of Sensors Manufactured At A Second Time After The First Time], first characterization data of the first sensor may be generated based on first calibration sensor data output by the first sensor. The first sensor may be from either a first batch of sensors manufactured at a first time or a second batch of sensors manufactured at a second time after the first time. In some embodiments, a calibration unit, such as the calibration unit 110 of FIG. 1a, may generate the first characterization data.

In block 704 [Provide The First Characterization Data To Be Pushed To Multiple Devices, Each Of The Devices Associated With One Sensor From A Group Of Second Sensors Of The First Batch Of Sensors And The Second Batch Of Sensors, The First Characterization Data Used By The Devices To Translate Field Sensor Data From The Group Of Second Sensors], the first characterization data may be provided to be pushed to multiple devices. In some embodiments, each of the devices may be associated with one sensor from a group of second sensors of the first batch of sensors and the second batch of sensors. In these and other embodiments, the first characterization data may be used by the devices to translate field sensor data from the group of second sensors. In these and other embodiments, the devices may be associated with the group of second sensors of the first batch of sensors and the second batch of sensors by inclusion of the group of second sensors in the devices. In some embodiments, an update unit, such as the update unit 220 of FIG. 2, may provide the first characterization data.

In block 706 [Collect Second Calibration Sensor Data Output By The First Sensor After Providing The First Characterization Data To Be Pushed To The Devices], second calibration sensor data output by the first sensor may be collected after the first characterization data is provided to be pushed to the devices. In some embodiments, a calibration unit, such as the calibration unit 110 of FIG. 1a, may collect second sensor data.

In block 708 [Generate Second Characterization Data Based On The Second Calibration Sensor Data], second characterization data may be generated based on the second calibration sensor data. In some embodiments, the first characterization data may describe a first relationship between a sensed parameter and the first calibration sensor data output by the first sensor at a third time. In these and other embodiments, the second characterization data may describe a second relationship between the sensed parameter and the second calibration sensor data output by the first sensor at a fourth time that is after the third time. In some embodiments, the first characterization data and the second characterization data may be in a form of an equation or a look-up table. In some embodiments, a calibration unit, such as the calibration unit 110 of FIG. 1a, may generate second characterization data.

In block 710 [Provide The Second Characterization Data To Be Pushed To The Devices], the second characterization data may be provided to be pushed to the devices. In some embodiments, the method 700 may further include collecting the first calibration sensor data from the first sensor. In these and other embodiments, the second calibration sensor data may be collected at a particular time period after the first calibration sensor data is collected. In these and other embodiments, the particular time period may be based on a change over time in a characterization curve of the first sensor with respect to a sensed parameter. In some embodiments, an update unit, such as the update unit 220 of FIG. 2, may provide the second characterization data.

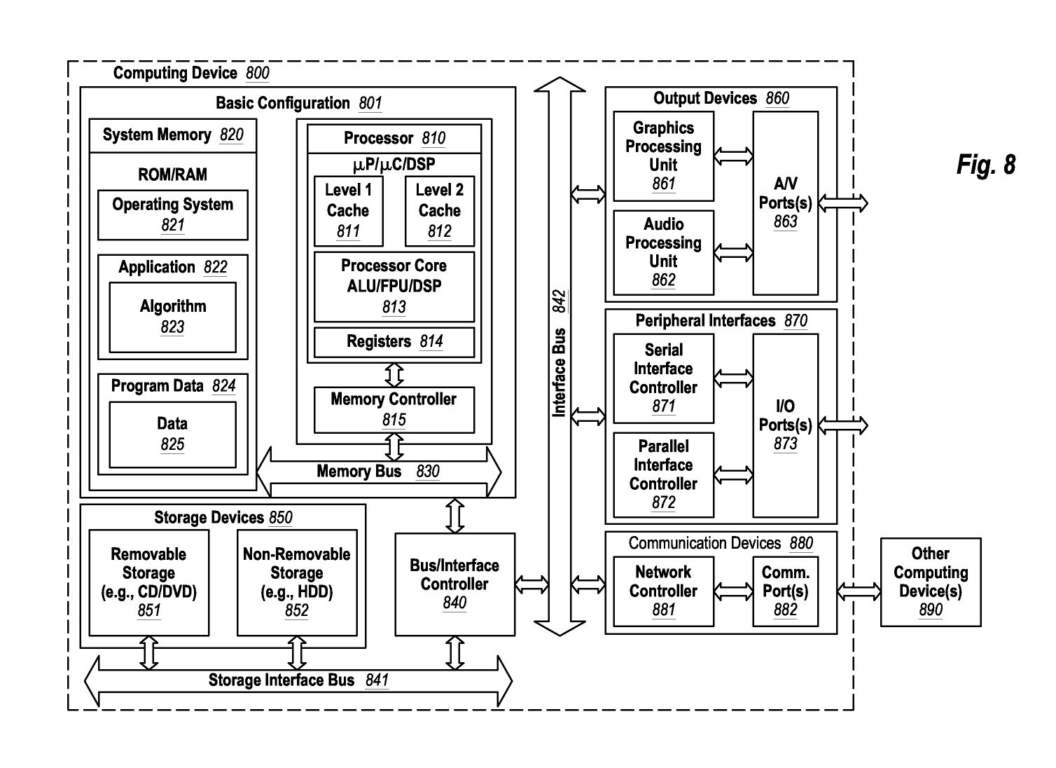

FIG. 8 is a block diagram illustrating an example computing device 800 which may be used in the example systems of FIG. 2, 3, or 4, arranged in accordance with at least some embodiments described herein. For example, the computing device 800 may be an example of one or more of the processor devices 234, 334, 354, and 412 of FIGS. 2, 3, and 4 and/or an example of a device in which such processor devices can be implemented. In a very basic configuration 801, the computing device 800 typically includes one or more processors 810 and a system memory 820. A memory bus 830 can be used for communicating between the processor 810 and the system memory 820.

Depending on the desired configuration, the processor 810 can be of any type including but not limited to a microprocessor (μP), a microcontroller (μC), a digital signal processor (DSP), or any combination thereof. The processor 810 can include one or more levels of caching, such as a level one cache 811 and a level two cache 812, a processor core 813, and registers 814. The processor core 813 can include an arithmetic logic unit (ALU), a floating point unit (FPU), a digital signal processing core (DSP Core), or any combination thereof. A memory controller 815 can also be used with the processor 810, or in some implementations the memory controller 815 can be an internal part of the processor 810.

Depending on the desired configuration, the system memory 820 may be of any type including, but not limited to, volatile memory (such as RAM), non-volatile memory (such as ROM, flash memory, etc.) or any combination thereof. The system memory 820 typically includes an operating system 821, one or more applications 822, and program data 824. The application 822 may include an algorithm 823. The program data 824 includes data 825 that is usable in connection with execution of the algorithm 823. For example, in some embodiments, the program data 824 may be sensor data and the algorithm 823 may be an algorithm that applies characterization data to the sensor data to determine a value of a parameter of an object represented by the sensor data. As another example, the algorithm 823 may be an algorithm used to update the characterization data of a sensor. Alternately or additionally, the algorithm 823 may be an algorithm used to control operation of a sensor when the sensor obtains sensor data. In some embodiments, the application 822 can be arranged to operate with the program data 824 on the operating system 821.

The computing device 800 can have additional features or functionality, and additional interfaces to facilitate communications between the basic configuration 801 and any required devices and interfaces. For example, a bus/interface controller 840 can be used to facilitate communications between the basic configuration 801 and one or more data storage devices 850 via a storage interface bus 841. The data storage devices 850 may be removable storage devices 851, non-removable storage devices 852, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media can include volatile and nonvolatile, removable and non-removable media implemented in any method or technology for storage of information, such as computer-readable instructions, data structures, program modules, or other data.

The system memory 820, the removable storage devices 851 and the non-removable storage devices 852 are all examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which can be used to store the desired information and which can be accessed by the computing device 800. Any such computer storage media can be part of the computing device 800.

The computing device 800 can also include an interface bus 842 for facilitating communication from various interface devices (e.g., output interfaces, peripheral interfaces, and communication interfaces) to the basic configuration 801 via the bus/interface controller 840. Example output devices 860 include a graphics processing unit 861 and an audio processing unit 862, which can be configured to communicate to various external devices such as a display or speakers via one or more A/V ports 863. Example peripheral interfaces 870 include a serial interface controller 871 or a parallel interface controller 872, which can be configured to communicate with external devices such as input devices (e.g., keyboard, mouse, pen, voice input device, touch input device, etc.) or other peripheral devices (e.g., printer, scanner, etc.) via one or more I/O ports 873. An example communication device 880 includes a network controller 881, which can be arranged to facilitate communications with one or more other computing devices 890 over a network communication via one or more communication ports 882.

The communication connection is one example of a communication media. Communication media may typically be embodied by computer-readable instructions, data structures, program modules, or other data in a modulated data signal, such as a carrier wave or other transport mechanism, and includes any information delivery media. A “modulated data signal” can be a signal that includes one or more of its characteristics set or changed in such a manner as to encode information in the signal. By way of example, and not limitation, communication media can include wired media such as a wired network or direct-wired connection, and wireless media such as acoustic, radio frequency (RF), infrared (IR), and other wireless media. The term computer-readable media as used herein can include both storage media and communication media.

The computing device 800 can be implemented as a portion of a small-form factor portable (or mobile) electronic device such as a cell phone, a personal data assistant (PDA), a personal media player device, a wireless web-watch device, a personal headset device, an application-specific device, or a hybrid device that includes any of the above functions. The computing device 800 can also be implemented as a personal computer including both laptop computer and non-laptop computer configurations.

The present disclosure is not to be limited in terms of the particular embodiments described herein, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The present disclosure is not limited to particular methods, reagents, compounds compositions, or biological systems, which can, of course, vary. The terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub ranges and combinations of sub ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into sub ranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, various embodiments of the present disclosure have been described herein for purposes of illustration, and various modifications may be made without departing from the scope and spirit of the present disclosure. Accordingly, the various embodiments disclosed herein are not intended to be limiting, with the true scope and spirit being indicated by the following claims.

What is claimed is:

1. A method of sensor degradation compensation, the method comprising:
generating first characterization data for calibration of a first sensor, from amongst a plurality of sensors that include the first sensor and at least a second sensor, based on first sensor data generated by the first sensor;
providing the first characterization data to be pushed to the second sensor, the second sensor configured to be calibrated with the first characterization data;
after the first characterization data is provided, collecting second sensor data generated by the first sensor;
generating second characterization data based on the second sensor data; and
providing the second characterization data to be pushed to the second sensor, the second sensor configured to be recalibrated with the second characterization data.

2. The method of claim 1, further comprising:
pushing the first characterization data to the second sensor; and
pushing the second characterization data to the second sensor, wherein the first characterization data is pushed to the second sensor in a different manner than the second characterization data is pushed to the second sensor.

3. The method of claim 2, wherein the second characterization data is pushed to the second sensor wirelessly by way of the Internet.

4. The method of claim 1, wherein the first characterization data and the second characterization data are in a form of an equation or a look-up table.

5. The method of claim 1, further comprising collecting the first sensor data generated by the first sensor, wherein the second sensor data is collected at a particular time period after the first sensor data is collected.

6. The method of claim 5, wherein the particular time period is based on a change over time in a characterization curve of the first sensor with respect to a sensed parameter.

7. The method of claim 1, wherein the plurality of sensors are manufactured at approximately a same time, wherein the method further comprises:
providing the first characterization data to be pushed to the plurality of sensors, each of the plurality of sensors configured to be calibrated with the first characterization data; and
after the first characterization data is provided, providing the second characterization data to be pushed to the plurality of sensors, each of the plurality of sensors configured to be recalibrated with the second characterization data.

8. A non-transitory computer-readable medium that includes computer-readable instructions stored thereon that are executable by a processor to perform or control performance of the method of claim 1.

9. A device configured to compensate for sensor degradation, the device comprising:
a transceiver configured to:
receive first sensor characterization data based on first calibration sensor data output by a first sensor; and
receive second sensor characterization data based on second calibration sensor data output by the first sensor; and
a processor device communicatively coupled to the transceiver and configured to:
apply the first sensor characterization data to first field sensor data received from a second sensor; and
apply the second sensor characterization data to second field sensor data received from the second sensor, wherein the second sensor characterization data and the second field sensor data are received by the transceiver after the first sensor characterization data is applied to the first field sensor data.

10. The device of claim 9, wherein the transceiver is further configured to receive the first field sensor data and the second field sensor data from the second sensor.

11. The device of claim 9, wherein the device further comprises the second sensor that is communicatively coupled to the transceiver, the second sensor is configured to generate the first field sensor data and the second field sensor data based on a sensed parameter.

12. The device of claim 9, wherein the processor device is further configured to generate presentation data based on application of the first sensor characterization data to the first field sensor data received from the second sensor.

13. The device of claim 12, wherein the transceiver is further configured to transmit the presentation data to another electronic device for presentation of the presentation data.

14. The device of claim 9, wherein the first sensor characterization data describes a first relationship between a sensed parameter and the first calibration sensor data output by the first sensor at a first time and the second sensor characterization data describes a second relationship between the sensed parameter and the second calibration sensor data output by the first sensor at a second time that is after the first time.

15. The device of claim 9, wherein the first sensor characterization data and the second sensor characterization data are in a form of an equation or a look-up table.

16. A method of sensor degradation compensation, the method comprising:
generating first characterization data for calibration of a first sensor, from amongst a plurality of sensors that include the first sensor and at least a second sensor, based on first calibration sensor data from the first sensor;
providing the first characterization data to be pushed to a device associated with the second sensor, the first characterization data used by the device to translate first field sensor data from the second sensor;
after the first characterization data is provided, collecting second calibration sensor data from the first sensor;
generating second characterization data based on the second calibration sensor data; and
providing the second characterization data to be pushed to the device, the second characterization data used by the device to translate second field sensor data from the second sensor.

17. The method of claim 16, wherein the second characterization data is used by the device in place of the first characterization data to translate the second field sensor data from the second sensor.

18. The method of claim 16, further comprising:
pushing the first characterization data to the device; and
pushing the second characterization data to the device, wherein the first characterization data is pushed to the device in a different manner than the second characterization data is pushed to the device.

19. The method of claim 16, wherein the first characterization data describes a first relationship between a sensed parameter and the first calibration sensor data from the first sensor at a first time and the second characterization data describes a second relationship between the sensed parameter and the second calibration sensor data from the first sensor at a second time that is after the first time.

20. The method of claim 16, wherein the first characterization data and the second characterization data are in a form of an equation or a look-up table.

21. The method of claim 16, further comprising collecting the first calibration sensor data from the first sensor, wherein the second calibration sensor data is collected at a particular time after the first calibration sensor data is collected.

22. The method of claim 21, wherein the particular time is based on a change over time in a characterization curve of the first sensor with respect to a sensed parameter.

23. The method of claim 16, wherein the device is associated with the second sensor when the device is configured to wirelessly receive the first and second field sensor data from the second sensor and apply the first characterization data to the first field sensor data and the second characterization data to the second field sensor data to generate presentation data to be presented to a user of the second sensor.

24. The method of claim 23, wherein the device includes a smart phone, tablet computer, smart watch, cellular phone, desktop computer, laptop computer, or server.

25. The method of claim 16, wherein the device is associated with the second sensor by inclusion of the second sensor in the device.

26. A non-transitory computer-readable medium that includes computer-readable instructions stored thereon that are executable by a processor to perform or control performance of the method of claim 16.

27. A non-transitory computer-readable medium that includes computer-readable instructions stored thereon that are executable by a processor to perform or control performance of operations of sensor degradation compensation, the operations comprising:
generating first characterization data of a first sensor based on first calibration sensor data output by the first sensor, the first sensor from either a first batch of sensors manufactured at a first time or a second batch of sensors manufactured at a second time after the first time;
providing the first characterization data to be pushed to a plurality of devices, each of the plurality of devices associated with one sensor from a group of second sensors of the first batch of sensors and the second batch of sensors, the first characterization data used by the plurality of devices to translate field sensor data from the group of second sensors;
collecting second calibration sensor data output by the first sensor after providing the first characterization data to be pushed to the plurality of devices;
generating second characterization data based on the second calibration sensor data; and
providing the second characterization data to be pushed to the plurality of devices.

28. The non-transitory computer-readable medium of claim 27, wherein the first characterization data describes a first relationship between a sensed parameter and the first calibration sensor data output by the first sensor at a third time and the second characterization data describes a second relationship between the sensed parameter and the second calibration sensor data output by the first sensor at a fourth time that is after the third time.

29. The non-transitory computer-readable medium of claim 27, wherein the first characterization data and the second characterization data are in a form of an equation or a look-up table.

30. The non-transitory computer-readable medium of claim 27, further comprising collecting the first calibration sensor data from the first sensor, wherein the second calibration sensor data is collected at a particular time period after the first calibration sensor data is collected.

31. The non-transitory computer-readable medium of claim 30, wherein the particular time period is based on a change over time in a characterization curve of the first sensor with respect to a sensed parameter.

32. The non-transitory computer-readable medium of claim 27, wherein the plurality of devices are associated with the group of second sensors of the first batch of sensors and the second batch of sensors by inclusion of the group of second sensors in the plurality of devices.
